(19) United States
(12) Patent Application Publication
(10) Pub. No.: US 2022/0118953 A1
(43) Pub. Date: Apr. 21, 2022

(54) METHOD FOR CLEANING A MOBILE UTILITY UNIT

(71) Applicant: DEERE & COMPANY, MOLINE, IL (US)

(72) Inventors: NORBERT FRITZ, ILVESHEIM (DE); MARTIN KREMMER, LAUMERSHEIM (DE)

(21) Appl. No.: 17/446,008

(22) Filed: Aug. 26, 2021

(30) Foreign Application Priority Data
Oct. 21, 2020 (DE) 102020127731.8

(51) Int. Cl. B60S 3/04; G05B 15/02; B08B 3/02; B08B 5/02; B08B 13/00; B25J 11/00; B25J 9/16

(52) U.S. Cl. CPC B60S 3/04; G05B 15/02; B08B 3/024; B25J 9/1694; B08B 13/00; B25J 11/0085; B08B 5/02

(57) ABSTRACT

A method for cleaning a mobile utility unit includes selecting a surface area of the mobile utility unit for cleaning via a data processing unit. The method includes cleaning the surface area of the mobile utility unit using a cleaning jet. The method includes during the cleaning step, generating current state data which represent a current cleaning state of the surface area via a sensor system connected to the data processing unit. The method includes comparing the current state data with provided comparative data via the data processing unit. The method includes selecting a different surface area of the mobile utility unit for cleaning via the data processing unit depending on a result of the comparison.

### RELATED APPLICATIONS

This application claims priority to German Patent Application No. 102020122304.8, filed Aug. 26, 2020, and German Patent Application No. 102020127731.8, filed Oct. 21, 2020, the disclosures of which are hereby expressly incorporated by reference in their entirety.

### FIELD OF THE DISCLOSURE

The present disclosure relates to a method for cleaning a mobile utility unit.

### BACKGROUND

Mobile utility units such as, e.g., agricultural or forestry vehicles, are normally maintained at defined time intervals. In many cases, a cleaning to remove dirt and the like from the surface of the utility unit is also performed as a maintenance measure.

There is a need to efficiently perform a cleaning for a mobile utility.

### SUMMARY

According to the present disclosure, a method is provided which serves to clean a mobile utility unit. The cleaning is intended to remove dirt, in particular, from the utility unit. This dirt occurs, for example, as a result of agricultural operational use of the utility unit. In this method, a surface area of the utility unit is selected which is intended to be cleaned. During the cleaning of the selected surface area, current state data are generated which represent a current cleaning state of this surface area. The current state data are compared with provided comparative data. Depending on a result of the comparison, the cleaning of the currently selected surface area is ended or a different or next surface area of the utility unit is selected for cleaning.

The aforementioned method steps enable a simple method structure which offers an efficient cleaning of the utility unit with little outlay in terms of data technology. The aforementioned method steps further allow a technically simple automation of the cleaning. An efficient cleaning of the utility unit is therefore possible with the method. The use of the comparison result of a data comparison for deciding whether a different or next surface area is selected for cleaning supports a time-saving cleaning procedure for achieving a desired cleaning result. The consideration of the comparison result further supports an economical use of the cleaning medium that is used. The workload of deployed maintenance personnel can further be reduced accordingly due to the automated cleaning.

The selection of a different surface area for cleaning depending on the comparison result means that, in the case of specific qualitative or quantitative comparison results, the currently selected surface area is further cleaned. Conversely, different qualitative or quantitative comparison results correspond to a desired cleaning result for the selected surface area so that a different or next surface area is selected for cleaning.

The cleaning procedure on a surface area is interrupted if current state data of this surface area are generated (e.g., by an optical sensor system).

Depending on a comparison result, the same surface area is further cleaned so that further current state data are generated for the same surface area. Prior to the selection of a different or next surface area for cleaning, current state data can therefore be generated multiple times in temporal succession for the currently selected surface area.

The surface areas to be cleaned are, in particular, part of the surface or external area of the utility unit. They may also be surface areas in the area of a wheel housing or underframe of the utility unit. In addition, surface areas which become accessible and visible only after an additional intervention (e.g., opening of a cover, protective lid, hood) are also conceivable for cleaning.

The provided comparative data represent a predefined reference cleaning state of the selected surface area. This predefined reference cleaning state can be regarded as a target cleaning state. The reference cleaning state must be achieved on the selected surface area either at 100% or at a lower defined percentage before the cleaning procedure on the selected surface area is ended and a different surface area is selected for cleaning. This can be controlled in a specific and automated manner for the respective application by a corresponding processing and evaluation of the comparison result (from the comparison of current state data with comparative data).

In a further embodiment, the comparative data represent a cleaning state of the currently selected surface area during its cleaning, but prior to the current cleaning state. The current state data of two consecutive cleaning times can thereby be compared with one another for a currently selected surface area during its cleaning. This allows a repeated comparison and an evaluation of the respective comparison result with little outlay in terms of data technology in order to be able to control an ending of the cleaning procedure in a specific and automated manner for the selected surface area for the respective application.

A different or next surface area is selected for cleaning only if the comparison result is at most as great as a predefined limit value. In other words, with this evaluation of the comparison results, the currently selected surface area is further cleaned as long as the comparison result exceeds the predefined limit value. By the limit value, and in a simple technical process, it is thus possible to decide whether or not the currently selected surface area sufficiently closely matches a desired cleaning state. The consideration of a limit value further enables a technically simple individual adjustment of the degree of cleaning depending on the utility unit to be cleaned, and an efficient automated performance of the cleaning procedure.

In particular, the comparison result represents a qualitative or quantitative difference between the comparative data and the current state data. In the case of image data, the aforementioned difference can represent, for example, a different number of pixels or a different color.

On the basis of the predefined limit value, it is possible to specify, in an application-specific manner, the quantitative or qualitative difference between the comparative data and the current state data at which the cleaning procedure can be ended for the currently selected surface area and a different surface area is selected for cleaning.

In one embodiment, the current state data must match the comparative data before the cleaning procedure is ended for a surface area. This can be achieved in a simple technical process with a predefined limit value equal to zero. In a further variant, the cleaning procedure is ended for a surface area if the differences between the current state data and the current comparative data are only small, i.e., do not exceed a predefined limit value greater than zero.

The performance of the cleaning procedure is supported by a movable cleaning jet which is moved using suitable technical means toward each individual surface area to be cleaned.

The cleaning jet is advantageously used to perform the cleaning procedure by a (e.g., high) pressure stream (wet or dry). A suitable medium or a plurality of media is/are used for this purpose. The media used may be liquid (e.g., water with cleaning agent) or gaseous (e.g., air).

The current cleaning state of the selected surface area is identified by a sensor system. An optical sensor system, e.g., at least one camera, is particularly suitable. The generated current state data are then compared, in particular as image data, with comparative data.

The “cleaning jet” component or the “sensor system” component or both components is/are part of a maintenance station. The maintenance station serves as a device for an efficient and automated performance of the cleaning method.

Method steps, such as, for example, comparing current state data with comparative data, selecting a different surface area for cleaning, and possibly other method steps also, are advantageously carried out in a data processing unit of the maintenance station. The latter contains all functions necessary for data processing, such as, for example, a microprocessor, a memory and suitable algorithms for processing and evaluating generated data and determined comparison results, and also for initiating further method steps such as, for example, ending the cleaning procedure on one surface area and selecting a different surface area for cleaning.

For the maintenance station, it may be advantageous to design it partially (along with the stationary partial area) or completely as a mobile maintenance unit. This mobile maintenance unit can be airborne (e.g., flying drone) or land-based (e.g., movable robot arm, travelling service vehicle). An at least partially mobile maintenance station can perform a cleaning of the mobile utility unit even more efficiently and economically under specific boundary conditions. This is the case, for example, if the geometric alignments of the different surface areas to be cleaned differ relatively substantially from one another. A mobile maintenance unit (e.g., drone, robot arm) is then moved with a cleaning jet attached it along a defined three-dimensional route in order to approach the different surface areas for cleaning.

In order to implement the feed of the cleaning medium or cleaning media to the cleaning jet in a space-saving manner and with little technical outlay, the cleaning jet is advantageously connected to a cleaning line which is stored in such a way that it can be coiled and uncoiled. The cleaning line serves to transport the cleaning medium or the cleaning media from an (in particular stationary) medium storage container. The cleaning line is stored, in particular, on a storage drum capable of rotational movement, of the type known, for example, from electrical cable drums. A space-saving effective working length of the cleaning line during the cleaning procedures is advantageously achieved by controlling the rotational movement of the storage drum by a drive unit (e.g., electric motor) depending on a detected movement of the cleaning jet.

In the case where a maintenance drone with a cleaning jet is used to clean the utility unit, it may be advantageous to use at least one further drone (to some extent as at least one further suspension point for the cleaning line) for mechanical support or for carrying the cleaning line during the cleaning procedure. Alternatively, a movable robot arm of the maintenance station can be used to support the cleaning line.

In addition, the maintenance drone can also be connected to an energy supply line or a data line. If necessary, these lines can similarly be mechanically suspended or supported by at least one further drone.

A robot arm with a cleaning jet connected to it is conceivable as an alternative to a coilable and uncoilable cleaning line with a cleaning jet connected to it. In this case, the robot arm has a delivery function for the cleaning medium or the cleaning media from an (in particular stationary) medium storage container through to the cleaning jet.

The medium storage container is, in particular, part of a stationary area of the maintenance station.

The automated cleaning according to the method is advantageously used in fields of application in which specific automation functions for increasing efficiency are particularly suitable, e.g., in large agricultural operations or in a (partially) autonomous vehicle fleet.

The mobile utility unit is a utility vehicle (e.g., an agricultural or forestry vehicle, construction vehicle) or an attachment (e.g., soil tillage implement, plough). The attachment can similarly be regarded as a mobile utility unit, insofar as it is movable at least in operational use. In particular, the attachment is coupled to the utility vehicle (e.g., tractor) and as a result is movable at least during the operational use of the utility vehicle.

The utility vehicle is designed, in particular, as a (partially) autonomous vehicle. An automated handling of the vehicle can be efficiently supported with the disclosed method steps.

### BRIEF DESCRIPTION OF THE DRAWINGS

The above-mentioned aspects of the present disclosure and the manner of obtaining them will become more apparent and the disclosure itself will be better understood by reference to the following description of the embodiments of the disclosure, taken in conjunction with the accompanying drawing, wherein:

FIG. 1 is a schematic diagram of a mobile utility unit and a maintenance station.

Corresponding reference numerals are used to indicate corresponding parts in the drawings.

### DETAILED DESCRIPTION

The embodiments of the present disclosure described below are not intended to be exhaustive or to limit the disclosure to the precise forms disclosed in the following detailed description. Rather, the embodiments are chosen and described so that others skilled in the art may appreciate and understand the principles and practices of the present disclosure.

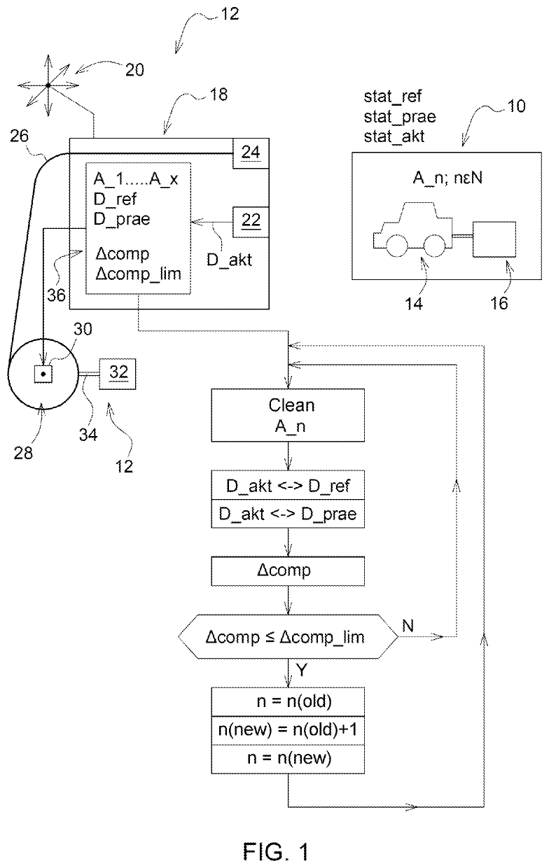

FIG. 1 shows schematically a mobile utility unit 10 and a maintenance station 12. The maintenance station 12 serves to maintain the utility unit 10, in particular for removing dirt and the like from the surface of the utility unit 10. Different method steps of the method for cleaning the utility unit 10 are shown in FIG. 1 in the form of a flow diagram.

The mobile utility unit 10 consists, for example, of a tractor 14 or an attachment 16 (e.g., a plough or other soil tillage implement, connected to it. The utility unit 10 is guided toward the maintenance station 12, either with a driver or as a (partially) autonomous vehicle, for maintenance or cleaning, in particular for cleaning its surface or external areas. The surface areas to be cleaned are denoted by the reference symbol A_n. Depending on the application and cleaning task, a different number of surface areas A_n can be provided for cleaning. The number n is therefore a selection from the natural numbers N=1 to infinity.

The maintenance station 12 contains a mobile maintenance unit 18 (e.g., a drone) whose movement is controlled in relation to the mobile utility unit 10 according to a defined (in particular three-dimensional) movement route, as indicated by the arrow directions 20.

A sensor system 22 (e.g., camera) and a cleaning jet 24 are disposed on the maintenance unit 18. A current cleaning state stat_akt of a surface area A_n selected for cleaning is identified by the sensor system 22. For this purpose, the sensor system 22 generates current state data D_akt which represent the current cleaning state stat_akt of the selected surface area A_n.

The cleaning jet 24 has a fluid connection to a cleaning line 26 which is stored on a rotatable storage drum 28 such a way that it can be coiled and uncoiled. In order to adapt the effective working length of the cleaning line 26 to the movements of the maintenance unit 18, the rotational movement of the storage drum 28 is controlled by a drive unit 30 (e.g., electric motor). The drive unit 30 is in turn controlled depending on a detected movement of the maintenance unit 18 and therefore of the cleaning jet 24.

The storage drum 28 and a storage container 32 for at least one cleaning medium are parts of the maintenance station 12. The at least one cleaning medium can be liquid (e.g., water with or without a cleaning agent) or gaseous (e.g., air). The cleaning procedure is carried out as high-pressure cleaning. The storage container 32 and the cleaning line 26 have a fluid connection to one another in the area of the storage drum 28 by a suitable fluid connection 34.

The generated current state data D_akt are fed to a data processing unit 36 which contains the usual data processing components such as, for example, a microprocessor, memory and the like. The data processing unit 36 is integrated into the maintenance unit 18. The data processing unit 36 controls the movements of the maintenance unit 18 and the rotational movements of the drive unit 30. Reference data D_ref which represent a predefined reference cleaning state stat_ref of the surface area A_n of the utility unit 10 selected for cleaning are stored and provided in the data processing unit 36. This predefined reference cleaning state can be regarded as a target cleaning state.

The reference data D_ref were generated prior to the current state data D_akt. The same sensor system 22 is used for this purpose which, particularly under identical specific conditions (e.g., illumination, light conditions, position of the sensor system in relation to the respective surface area A_n of the utility unit 10), first generates the reference data D_ref and later, during the cleaning, the current state data D_akt.

Information indicating which surface areas A_n of the respective utility unit 10 are intended to be cleaned, for example the surface areas A_1 to A_x, is stored in the maintenance station 12, particularly in the data processing unit 36. At the start of the cleaning procedure, a first surface area A_n (n=1) of the utility unit 10 is first selected and the cleaning jet 24 is guided toward it. The cleaning activity of the cleaning jet 24 on the selected surface area A_n is interrupted multiple times if necessary in order to generate current state data D_akt from this selected surface area A_n by the sensor system 22. These current state data D_akt are compared in the data processing unit 36 with the reference data D_ref serving as the comparative data. A comparison result Δcomp, e.g., a mathematical difference, is obtained from this comparison.

Generally speaking, the comparison result Δcomp represents differences (e.g., quantitative or qualitative) between the comparative data or reference data D_ref and the current state data D_akt.

Depending on the determined comparison result Δcomp, it is decided whether the currently selected surface area A_n (n=n(old)) requires further cleaning or whether a different or next surface area A_n (n=n(new)=n(old)+1) is selected for cleaning. The comparison result Δcomp is correlated with a predefined limit value Δcomp lim for this purpose. In particular, a check is carried out to determine whether the comparison result is at most as great as the predefined limit value Δcomp lim. If this condition is satisfied, the predefined degree of cleaning is achieved on the currently selected surface area A_n and a different surface area A_n is selected for cleaning. If the aforementioned condition is not satisfied, the currently selected surface area A_n is further cleaned and current state data D_akt are again generated.

In connection with the comparison result Δcomp, it should be noted that this reference symbol—depending on the type of the comparative data and the current state data D_akt (e.g., image data, pixels, colors)—can represent different numerical values and possibly different physical units. The same applies to the predefined limit value Δcomp_lim. The latter is qualitatively or quantitatively adapted to the respectively desired degree of cleaning of the utility unit 10.

In a further embodiment, the comparative data do not represent a predefined reference cleaning state stat_ref, but rather a cleaning state stat_prae prior to the current cleaning state stat_akt during the same cleaning procedure for the currently selected surface area A_n. These comparative data are stored as superseded state data D_prae of the currently selected surface area A_n in the data processing unit 36 and are provided for a comparison with the current state data D_akt. In a next comparison, the latest current state data form the most recent superseded state data D_prae. The latter are compared with the newly generated current state data D_akt. In this way, the respective most recent superseded state data D_prae can be compared, if necessary multiple times in temporal succession, with respective current state data D_akt during a cleaning procedure on a selected surface area A_n. This comparison takes place until the comparison result Δcomp is at most as great as the predefined limit value Δcomp lim. The limit value Δcomp_lim is predefined in such a way that the difference between the current state data D_akt and the superseded state data D_prae is relatively small and therefore a further cleaning of the currently selected surface area A_n is not efficient. In this case, as explained above, a different or next surface area A_n is selected for cleaning.

While embodiments incorporating the principles of the present disclosure have been disclosed hereinabove, the present disclosure is not limited to the disclosed embodiments. Instead, this application is intended to cover any variations, uses, or adaptations of the disclosure using its general principles. Further, this application is intended to cover such departures from the present disclosure as come within known or customary practice in the art to which this disclosure pertains and which fall within the limits of the appended claims.

1. A method for cleaning a mobile utility unit, comprising:
selecting a surface area of the mobile utility unit for cleaning via a data processing unit;
cleaning the surface area of the mobile utility unit using a cleaning jet;
during the cleaning step, generating current state data which represent a current cleaning state of the surface area via a sensor system connected to the data processing unit;
comparing the current state data with provided comparative data via the data processing unit; and
selecting a different surface area of the mobile utility unit for cleaning via the data processing unit depending on a result of the comparison.

2. The method of claim 1, wherein the comparative data represent a predefined reference cleaning state of the selected surface area.

3. The method of claim 1, wherein the comparative data represent a cleaning state of the selected surface area during its cleaning prior to the current cleaning state.

4. The method of claim 1, wherein the different surface area is selected when the result of the comparison satisfies a predefined limit value.

5. The method of claim 1, wherein the cleaning jet includes a movable cleaning jet.

6. The method of claim 1, wherein cleaning the surface area includes using a liquid or gaseous medium for cleaning.

7. The method of claim 1, wherein the sensor system includes an optical sensor system.

8. The method of claim 1, wherein the data processing unit, the cleaning jet, and the sensor system are part of a maintenance station.

9. The method of claim 8, wherein the maintenance station includes a mobile maintenance unit.

10. The method of claim 1, further comprising:
controlling a drive unit via the data processing unit to coil and uncoil a cleaning line connected to the cleaning jet depending on movement of the cleaning jet.

11. The method of claim 1, wherein the mobile utility unit includes one or more of a utility vehicle, an attachment, and an autonomous vehicle.

12. A method for cleaning a mobile utility unit using a maintenance station, comprising:
selecting a surface area of the mobile utility unit for cleaning via a data processing unit;
cleaning the surface area of the mobile utility unit using a movable cleaning jet connected to a cleaning line;
controlling a drive unit via the data processing unit to coil and uncoil a cleaning line connected to the movable cleaning jet depending on movement of the movable cleaning jet
during the cleaning step, generating current state data which represent a current cleaning state of the surface area via an optical sensor system connected to the data processing unit;
comparing the current state data with provided comparative data via the data processing unit, the comparative data represent a predefined reference cleaning state of the selected surface area; and
selecting a different surface area of the mobile utility unit for cleaning via the data processing unit when a result of the comparison satisfies a predefined limit value.

13. A maintenance station for cleaning a mobile utility unit, comprising:
a sensor system generating current state data which represent a current cleaning state of a surface area;
a cleaning jet providing medium to the surface area; and
a data processing unit connected to the sensor system;
the data processing unit comparing the current state data with provided comparative data, the comparative data representing a predefined reference cleaning state of the surface area; and
the data processing unit selecting a different surface area for cleaning when a result of the comparison satisfies a predefined limit value.

14. The maintenance station of claim 13, further comprising:
the data processing unit controlling the drive unit to coil and uncoil a cleaning line connected to the cleaning jet depending on movement of the cleaning jet.

15. The maintenance station of claim 13, wherein the cleaning jet includes a movable cleaning jet.

16. The maintenance station of claim 13, wherein the sensor system includes an optical sensor system.

17. The maintenance station of claim 13, wherein the maintenance station includes a mobile maintenance unit.

18. The maintenance station of claim 13, wherein the maintenance station includes a drone.

19. The maintenance station of claim 13, wherein the maintenance station includes a robot arm.

20. The maintenance station of claim 13, wherein the mobile utility unit includes one or more of a utility vehicle, an attachment, and an autonomous vehicle.
